(19) United States
(12) Patent Application Publication
(10) Pub. No.: US 2011/0249202 A1
(43) Pub. Date: Oct. 13, 2011

(54) POWER REDUCTION TELEVISION WITH PHOTO FRAME

(75) Inventors: Sang Hee PARK, Daejeon (KR); Chi Sun Hwang, Daejeon (KR); Min Ki Ryu, Seoul (KR)

(73) Assignee: ELECTRONICS AND TELECOMMUNICATIONS RESEARCH INSTITUTE, Daejeon (KR)

(21) Appl. No.: 13/080,831

(22) Filed: Apr. 6, 2011

(30) Foreign Application Priority Data
Apr. 9, 2010 (KR) 10-2010-0032559

(51) Int. Cl. H04N 5/66; H04N 3/14

(52) U.S. Cl. 348/790; 348/739; 348/E05.133; 348/E03.016

(57) ABSTRACT

A power reduction television with a photo frame is provided. The power reduction television includes a first display configured to display a first video image, a low power second display configured to display a second video image, and a display control unit configured to control the second display to display the second video image, when the first video image is not displayed through the first display.

### CROSS-REFERENCE TO RELATED APPLICATION

This application claims priority to and the benefit of Korean Patent Application No. 10-2010-0032559, filed Apr. 9, 2010, the disclosure of which is incorporated herein by reference in its entirety.

### BACKGROUND

1. Field of the Invention

The present invention relates to a television, and more specifically, to a power reduction television with a photo frame.

2. Discussion of Related Art

As the development of technology for flat panel displays such as thin film transistor-liquid crystal displays (TFT-LCDs), plasma display panels (PDPs), etc. televisions are becoming larger and larger. With the technology development of the flat panel displays, sensitive television models with various designs have been developing.

However, as wide black display occupies an interior space or a wall, appearance is not good when the television is not in use. Accordingly, in order to solve this problem, current digital televisions have display functions of photos or pictures to be used as electronic frames.

However, when the pictures or photos are displayed through the conventional television, power is largely consumed in the conventional television used as the electronic frame. Especially, the high priced televisions cannot be used as the electronic frame due to a cost according to a limited life span of a main module.

As one method to solve this problem, it is possible to mount a transparent display at a front of a display of the television. However, the transparent display must be constituted of a transmissive display with bistability to reduce power consumption, instead of a self-emissive display. In addition, it is difficult to develop the technique without shortening the life span of the main module of the television. Furthermore, even if the transparent display is adapted, it cannot guarantee picture quality of the television due to attachment of the transparent reflective display on the display of the television.

### SUMMARY OF THE INVENTION

The present invention is directed to a power reduction television with a photo frame which is constituted of an additional low power display displaying a picture or photo to be used as an electronic frame when the television is not in use such that power consumption of the television can be minimized and a life span can be maximized. In addition, a video image can be seen without deterioration of picture quality.

One aspect of the present invention provides a power reduction television with a photo frame including a first display configured to display a first video image, a low power second display configured to display a second video image, and a display control unit configured to control the second display to display the second video image, when the first display do not display the first video image.

The television may further include a command input unit configured to receive a display command for the first video image or a display command for the second video image from a user. The display control unit may control the first display not to display the first video image and the second display to display the second video image, when the display control unit receives the command for the second video image through the command input unit.

The second display may be disposed at a back of the first display.

The first video image may be a broadcasting video image, a digital video disc (DVD) player reproducing video image, a video player reproducing video image, a game video image of a game console or an internet moving video image, and the second video image may be a still video image.

The television may further include a display housing unit configured to store the second display. The second display may be a flexible display, drawn from the display housing unit in a sliding manner, and disposed over the first display to display the second video image.

The second display may be drawn from the display housing unit and be disposed over the first display through a top, bottom, left side or right side of the first display on a basis of a display direction of the first display.

The display control unit may invert a top and bottom of the still video image to display an inverted still video image, when the second display is drawn to be disposed over the first display through the top or bottom of the first display.

The second display may be a reflective display.

The second display may be an electrophoretic display, an electrochromic display, a wetting display or a polymer dispersed liquid crystal (PDLC) display.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a diagram illustrating a power reduction television with a photo frame according to an exemplary embodiment of the present invention;

FIGS. 2 and 3 are diagrams illustrating a power reduction television with a photo frame according to another exemplary embodiment of the present invention; and

FIG. 4 illustrates the construction of a power reduction television with a photo frame according to an exemplary embodiment of the present invention.

### DETAILED DESCRIPTION OF EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In drawings, portions unrelated to description will be omitted to distinctly describe the present invention and similar reference numerals are labeled to similar portions throughout the specification.

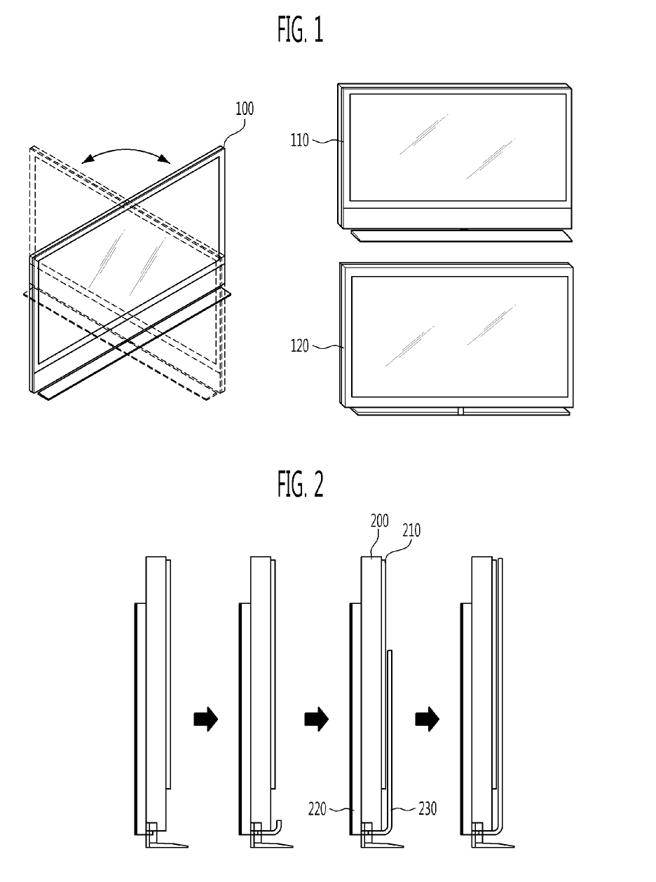

FIG. 1 is a diagram illustrating a power reduction television with a photo frame according to an exemplary embodiment of the present invention. The construction of the power reduction television with a photo frame according to an exemplary embodiment of the present invention will be described with reference with FIG. 1.

Referring to FIG. 1, a power reduction television 100 of the present invention includes a first display 110 and a second display 120.

The first display 110 is disposed at a front of the television 100 and the second display 120 is disposed at a back of the television 100. Accordingly, a user watches a broadcasting video image, a digital video disc (DVD) player video image, a video player reproducing video image, a game video image of a game console, or an internet moving video image through the first display disposed at the front of the television as usual. When the user does not watch the above video images, the television 100 may be rotated and used as an electronic photo frame which displays a still video image such as a photo, a picture, etc. through the second display 120 disposed at the back thereof.

At this time, the second display 120 may be a low power display. The second display 120 may be a reflective display. In addition, the second display 120 may be formed of various substrates such as a glass substrate, a plastic substrate, a steel use stainless (SUS) substrate, etc. For example, the second display 120 may be an electrophoretic display, an electrochromic display, a wetting display, a polymer dispersed liquid crystal (PDLC) display, etc.

According to the present invention, when the user does not watch the video image through the television, the television is used as the electronic photo frame such that the power consumption of the television can be minimized and the life span of a display module of the television can be maximized. Furthermore, when the video image is displayed through the television, the user can watch the video image without deterioration of the picture quality.

FIGS. 2 and 3 are diagrams illustrating power reduction televisions with photo frames according to other exemplary embodiments of the present invention. FIGS. 2 and 3 illustrate televisions configured to move second displays 230 and 330 disposed at backs of the televisions to tops of first displays 210 and 310.

Referring to FIG. 2, a power reduction television 200 with a photo frame according to the present invention includes the first display 210, the second display 230 and a display housing unit 220 configured to house the second display 230.

The second display 230 may be a flexible display, and the second display 230 may be drawn from the display housing unit 220 in a sliding manner and be disposed over the first display 210 to blind the first display 210 such that the still video image is displayed through the second display 230. That is, when the broadcasting is not watched through the television 200, the second display 230 housed in the display housing unit 220 at the back of the television 200 is drawn to a front of the first display 210 through the bottom of the television 200 in a rolling manner to be used as the electronic photo frame.

Alternatively, a power reduction television 300 with a photo frame according to the present invention may be configured to draw the second display 330 housed in a display housing unit 320 at a back side of the television 300 to a front of the first display 310 through the top of the television 300 in the rolling manner to be used as the electronic photo frame as illustrated in FIG. 3. In addition, in another exemplary embodiment, the television may be configured to draw the second display housed in the display housing unit at the back of the television to the front of the first display through a left or right of the television in the rolling manner

At this time, the second displays 230 and 330 may be low power displays and formed of reflective displays. In addition, the second displays 230 and 330 may be especially an electrophoretic display, an electrochromic display, a wetting display, a PDLC display, etc.

On the other hand, the display housing unit 220 may be formed of a transparent material for the user to watch the still video image displayed on the second display 230 when the second display 230 is housed in the display housing unit 220. In addition, the display housing 220 may have the shape of a guide frame to slide the second display 230 over the first display 210.

According to the present invention, the user may watch the video image by receiving a broadcasting signal through the first displays 210 and 310 disposed at the fronts of the televisions 200 and 300 as usual. When the user does not watch the video image as above, the user may draw the second displays 220 and 320 which are disposed at the backs of the televisions 200 and 300 to the front of the televisions 200 and 300. Accordingly, the televisions 200 and 300 may be used as the electric photo frames which display a still video image such as a photo or still image.

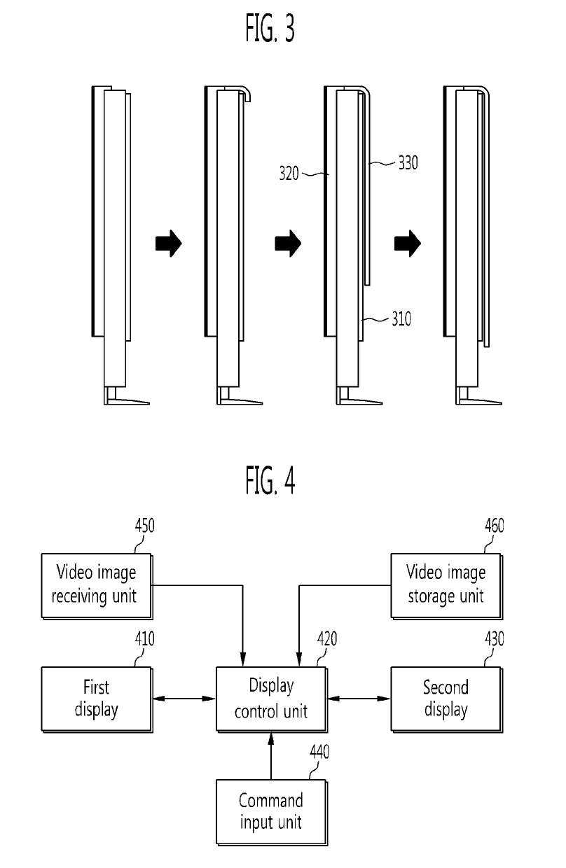

FIG. 4 is a construction diagram of a power reduction television with a photo frame according to an exemplary embodiment of the present invention. The construction of the power reduction television with a photo frame will be described with reference to FIG. 4.

Referring to FIG. 4, the power reduction television with a photo frame according to an exemplary embodiment includes a first display 410, a second display 430, and a display control unit 420. The television may further include a command input unit 440, a video image receiving unit 450, and a video image storage unit 460.

The first display 410 may be disposed at one side of the television and the second display 430 may be disposed at the other side of the television. That is, the first display 410 may be disposed at a front of the television and the second display 430 may be disposed at a back of the television.

The video image receiving unit 450 may receive various video images such as a broadcasting video image, a DVD player reproducing video image, a video player reproducing video image, a game video image of a game console, an internet moving video image, etc.

The video image storage unit 460 may store a still video image and the still video image stored in the video image storage unit 460 may be one of various still images such as a photo, a picture, etc.

The command input unit 440 receives a command from a user.

If the display control unit 420 receives a display command for a first video image through the command input unit 440, the first display 410 displays the first video image. If the display control unit 420 receives a display command for a second video image through the command input unit 440, the second display 430 displays the second video image. For example, if the display control unit 420 receives the display command for a first video image through the command input unit 440, the display control unit 420 may control the first display 410 to display the various video images such as a broadcasting video image, a DVD player reproducing video image, a video player reproducing video image, a game video image of a game console, an internet moving video image, etc. If the display control unit 420 receives the display command for a second video image, that is, the display command for the still video image through the command input unit 440, the display control unit 420 may control the second display 430 to display the still video image.

The display control unit 420 controls the second display 430 to display the second video image when the first display 410 does not display the first video image.

The command input unit 440 may receive a command for a first video image or a command for a second video image from the user. If the display control unit 420 receives the command for a second video image from the command input unit 440, the display control unit 420 may be configured to control the first display 410 not to display the first video image and the second display 430 to display the second video image.

The second display 430 displaying the second video image may be a flexible display. The second display 430 may be configured to be drawn from a display housing unit in a sliding manner to be disposed over the first display 410. The second display 430 may be drawn from the display housing unit through a top, bottom, left side, or right side of the television on the basis of a display direction of the first display 410. At this time, the display control unit 420 may invert a top and a bottom of the still video image to display an inverted still video image accurately, when the second display 430 is drawn through the top or bottom of the first display 410.

At this time, the second display 430 may be a reflective display or a low power display and the second display 430 may be formed of glass, plastic, SUS, etc. For example, the second display 430 may be an electrophoretic display, an electrochromic display, a wetting display, a PDLC display, etc.

According to the present invention, when the user does not use a television to watch the video image, the television is used as an electronic frame such that the power consumption of the television can be minimized and the life span of a display module of the television can be maximized. In addition, the user can watch the video image through the television without deterioration of the picture quality.

In addition, a television occupying a large portion of the interior space is used as an electric photo frame which is able to display a photo or a picture to provide an indoor environment with more aesthetic sense.

Furthermore, a television serving as an electronic photo frame is provided without adaptation of a display for a frame to overcome technical difficulties in fabricating the display for a transparent frame and to rapidly realize the market entry.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A power reduction television with a photo frame, comprising:
a first display configured to display a first video image;
a low power second display configured to display a second video image; and
a display control unit configured to control the second display to display the second video image, when the first video image is not displayed through the first display.

2. The power reduction television of claim 1, further comprising a command input unit configured to receive a display command for the first video image or a display command for the second video image from a user,
wherein the display control unit controls the first display not to display the first video image and the second display to display the second video image, if the display control unit receives the display command for the second video image through the command input unit.

3. The power reduction television of claim 1, wherein the second display is disposed at a back of the first display.

4. The power reduction television of claim 1, wherein the first video image is any one of a broadcasting video image, a digital video disc (DVD) player reproducing video image, a video player reproducing video image, a game video image of a game console, and an internet moving video image, and the second video image is a still video image.

5. The power reduction television of claim 1, further comprising a display housing unit configured to house the second display,
wherein the second display is a flexible display, drawn from the display housing unit in a sliding manner, and disposed over the first display to display the second video image.

6. The power reduction television of claim 5, wherein the second display is drawn from the display housing unit through a top, bottom, left side, or right side of the first display on the basis of a display direction of the first display to be disposed over the first display.

7. The power reduction television of claim 6, wherein the display control unit inverts a top and a bottom of a still video image to display an inverted still video image, when the second display is drawn through the top or bottom of the first display to be disposed over the first display.

8. The power reduction television of claim 1, wherein the second display is a reflective display.

9. The power reduction television of claim 1, wherein the second display is any one of an electrophoretic display, an electrochromic display, a wetting display, and a polymer dispersed liquid crystal (PDLC) display.
